(19) United States
(12) Patent Application Publication
(10) Pub. No.: US 2004/0045323 A1
(43) Pub. Date: Mar. 11, 2004

(54) Method and apparatus for concentrically forming an optical preform using laser energy

(75) Inventors: Peter Schultz, Bogart, GA (US); Dmitri Nikitin, Daytona Beach Shores, FL (US); Thomas Michel, Eustis, FL (US); Vladimire Borissovskii, Lake Mary, FL (US)

Correspondence Address: FINNEGAN, HENDERSON, FARABOW, GARRETT & DUNNER, LLP, 1300 I STREET, NW, WASHINGTON, DC, 20005, US

(73) Assignee: Heraeus Tenevo, Inc.

(21) Appl. No.: 10/660,290

(22) Filed: Sep. 11, 2003

Related U.S. Application Data
(63) Continuation of application No. 09/846,006, filed on Apr. 30, 2001.
Application No. 09/846,006 is a continuation-in-part of application No. 09/516,937, filed on Mar. 1, 2000, now abandoned.

(51) Int. Cl. C03B 37/012

(52) U.S. Cl. 65/392; 65/43; 65/57; 65/153; 65/407; 65/412; 219/121.64; 219/121.63

(57) ABSTRACT

Methods, systems, and apparatus consistent with the present invention use a beam of laser energy to concentrically form an optical preform from two or more concentric glass objects, such as two glass tubes or a hollow glass tube and a solid glass rod. The glass objects are placed in a concentric configuration where the outer object has an inner surface that is placed proximate to an outer surface of the inner object. Once these are assembled, a beam of laser energy is generated, positioned, and applied to a starting point in the gap defined by the inner surface and the outer surface. Once the laser beam is applied and is reflecting down into the gap, the beam of laser energy is moved relative to the starting point as the beam is concurrently applied. This heats the inner surface and outer surface so that the two objects can be joined to form the optical preform. In another aspect of the invention, a coating layer is disposed within the gap and can be heated by the laser as it is applied within the gap. Such heating of the coating layer causes thermal diffusion of the coating layer into at least one of the glass objects prior to fusing the glass objects together.

### RELATED APPLICATIONS

This application is a continuation-in-part of U.S. patent application Ser. No. 09/516,937 entitled METHOD APPARATUS AND ARTICLE OF MANUFACTURE FOR DETERMINING AN AMOUNT OF ENERGY NEEDED TO BRING A QUARTZ WORKPIECE TO A FUSION WELDABLE CONDITION, which was filed on Mar. 1, 2000. This application is also related to several commonly owned applications that were concurrently filed on as follows: U.S. patent application Ser. No. __/___,___ entitled “METHOD AND APPARATUS FOR FUSION WELDING QUARTZ USING LASER ENERGY”, U.S. patent application Ser. No. __/___,___ entitled “METHOD AND APPARATUS FOR PIERCING AND THERMALLY PROCESSING QUARTZ USING LASER ENERGY”, U.S. patent application Ser. No. __/___,___ entitled “METHOD AND APPARATUS FOR CREATING A REFRATIVE GRADIENT IN GLASS USING LASER ENERGY”, and U.S. patent application Ser. No. __/___,___ entitled “METHOD AND APPARATUS FOR THERMALLY PROCESSING QUARTZ USING A PLURALITY OF LASER BEAMS.”

### BACKGROUND OF THE INVENTION

A. Field of the Invention

This invention relates to systems for thermally processing glass or quartz using laser energy and, more particularly stated, to systems and methods for concentrically forming an optical preform from concentrically assembled tubes of glass that are heated (e.g., fusion welded) with a beam of laser energy applied between the assembled tubes.

B. Description of the Related Art

One of the most useful industrial glass materials is quartz glass. It is used in a variety of industries: optics, semiconductors, chemicals, communications, architecture, consumer products, computers, and associated industries. In many of these industrial applications, it is important to be able to join two or more pieces together to make one large, uniform blank or finished part. For example, this may include joining two or more rods or tubes “end-to-end” in order to make a longer rod or tube. Additionally, this may involve joining two thick quartz blocks together to create one of the walls for a large chemical reactor vessel or a preform from which optical fiber can be made. These larger parts may then be cut, ground, or drawn down to other usable sizes.

Many types of glasses have been “welded” or joined together with varying degrees of success. For many soft, low melting point types of glass, these attempts have been more successful than not. However, for higher temperature compounds, such as quartz, welding has been difficult. Even when welding of such higher temperature compounds is possible, the conventional processes are typically quite expensive and time-consuming due to the manual nature of such processes and the required annealing times.

When attempting to weld quartz, a critical factor is the temperature of the weldable surface at the interface of the quartz workpiece to be welded. The temperature is critical because quartz itself does not go through what is conventionally considered to be a liquid phase transition as do other materials, such as steel or water. Quartz sublimates, i.e., it goes from a solid state directly to a gaseous state. Those skilled in the art will appreciate that quartz sublimation is at least evident in the gross sense, on a macro level.

In order to achieve an optimal quartz weld, it is desirable to bring the quartz to a condition near sublimation but just under that point. There is a relatively narrow temperature zone in that condition, typically between about 1900 to 1970 degrees Celsius (C.), within which one can optimally fusion weld quartz. In other words, in that usable temperature range, the quartz object will fuse to another quartz object in that their molecules will become intermingled and become a single piece of water clear glass instead of two separate pieces with a joint. However, quartz vaporizes above that temperature range, which essentially destroys part of the quartz workpiece at the weldable surface. Thus, achieving an optimal quartz fusion weld is not trivial and typically involves controlling how much energy is applied so that the quartz workpiece or object reaches a weldable condition without being vaporized.

In addition to using laser energy to fusion weld quartz together, there is a need for a method or system that can quickly and easily create an optical preform used to make optical fibers. Today, a majority of silica glass fiber optics for telecommunications are made using vapor deposition techniques in quartz glass. One conventional method, called MCVD, begins with a bait tube of quartz or highly purified silica (SiO₂). The tube is generally heated with a flame as the tube is rotated. When reactant gases (e.g., metal halides and oxygen) pass through the heated tube, they react to deposit layers of a soot material on the inside diameter surface of the tube. Heat from the flame then melts the soot to form a sintered glass having a desired refractive gradient characteristic. These layers form concentric rings of glass. When the heat from the flame is turned up, the tube and the deposited rings collapse into a solid rod (also called an optical preform) where the deposited rings of sintered glass become the light-carrying core of the fiber while the rest of the tube forms the cladding for the fiber. These conventional fabrication methods are known to be effective, but are undesirably time-intensive.

Accordingly, there is a need for an improved system and method that can more quickly, efficiently, and economically process quartz to create optical preforms in a way not found before.

### SUMMARY OF THE INVENTION

Methods, systems, and articles of manufacture consistent with the present invention overcome these shortcomings by using laser energy to concentrically form an optical preform. The directed nature and precision of beams of laser energy provide a way in which to directly apply energy to heat a gap between concentrically assembled glass tubes that will make up different layers (e.g., cladding, core, etc.) of the preform. As the gap is heated with the laser beam, the assembled tubes are joined together, thus efficiently creating the preform two or more close fitting glass tubes.

More particularly stated, a method consistent with the present invention, as embodied and broadly described herein, begins with placing a first glass tube around a second glass tube in a concentric configuration. The first glass tube has an inner surface. The second glass tube has an outer surface that is placed proximate to the inner surface of the first glass tube. Next, the beam of laser energy is directed between the inner surface of the first glass tube and the outer surface of the second glass tube to fuse the first glass tube to the second glass tube, thus forming the optical preform. More particularly stated, the beam of laser energy is positioned in an initial orientation with respect to the first glass tube and the second glass tube before the beam is applied between the inner surface and the outer surface. Further, the beam of laser energy may be moved relative to the first and second glass tubes as the beam is applied. Such movement may incorporate rotating the beam relative to the first glass tube causing the beam to selectively heat the inner surface and the outer surface as the beam reflects between the inner surface and the outer surface. In other words, the movement may involve rotating the beam of laser energy about a longitudinal axis of the first glass tube while concurrently reflecting the beam of laser energy between the inner surface and the outer surface causing the inner surface and the outer surface to fusion weld together.

The second glass tube may have a coating layer disposed on the outer surface. In such a case, the beam of laser energy is applied to the coating layer which selectively heats the coating layer causing diffusion of the coating layer into at least the second tube and possibly into the first tube as well. After such selective heating of the coating layer, the first and second glass tube are fusion welded together using the beam of laser energy, thus forming the optical preform.

In another aspect of the present invention, as embodied and broadly described herein, a method for concentrically forming an optical preform using a beam of laser energy begins by assembling at least one hollow glass tube concentrically around a solid glass rod. The hollow glass tube has an inner or inside diameter (ID) surface and the solid glass rod has an outer surface. The inner surface and the outer surface collectively define a cylindrical gap between the hollow glass tube and the solid glass rod. Next, a beam of laser energy is generated within a laser energy source and positioned in an initial configuration with respect to the concentrically assembled tubes such that it is applied to a starting point within the cylindrical gap. As the beam is applied, the beam is moved relative to the starting point in order to join the inner surface to the outer surface and form the optical preform. Moving the beam of laser energy may further involve rotating the beam from a rotational starting angle around the solid glass rod causing the beam of laser energy to selectively heat the inner surface and the outer surface as the beam is reflected within the cylindrical gap. In other words, the movement involved rotating the beam of laser energy about a longitudinal axis of the solid glass rod while concurrently applying the beam of laser energy to each of the inner surface and the outer surface causing the inner surface and the outer surface to fusion weld together.

The solid glass rod may have a coating layer disposed on its outer surface. In this case, the beam of laser energy is applied to the coating layer at the starting point. The beam of laser energy is moved relative to the starting point as the applied beam causes thermal diffusion of the coating layer into at least the solid glass rod. Continued application of the beam within the cylindrical gap causes the hollow glass tube and the solid glass rod to fusion weld together and form the optical perform after causing diffusion of the coating layer.

In yet an other aspect of the present invention, as embodied and broadly described herein, an apparatus for concentrically forming an optical preform using a beam of laser energy is described as having a processor, a communication interface coupled to the processor, a laser energy source and communication with the processor and a working surface in communication with the processor. The laser energy source is in communication with the processor via the communications interface. The laser energy source is capable of selectively providing a beam of laser energy in response to laser control signals from the processor.

The working surface is in communication with the processor via the communications interface. This supports a hollow glass tube that is concentrically assembled around a solid glass rod having a longitudinal axis. The hollow glass tube has an inside diameter (ID) surface and the solid glass rod has an outer surface that is proximate to the ID surface of the hollow glass tube. The ID surface and the outer surface define a cylindrical gap between the hollow glass tube and the solid glass rod.

Finally, the apparatus includes a reflective conduit in communication with the processor via the communications interface. The reflective conduit is configured to received the beam of laser energy from the laser energy source and to adjustably provide the beam of laser energy down into the cylindrical gap in response to conduit positioning signals from the processor.

### BRIEF DESCRIPTION OF THE DRAWINGS

The accompanying drawings, which are incorporated in and constitute a part of this specification, illustrate an implementation of the invention. The drawings and the description below serve to explain the advantages and principles of the invention. In the drawings,

FIG. 1, consisting of FIGS. 1A-1D, is a diagram illustrating an exemplary quartz laser fusion welding system consistent with an embodiment of the present invention;

FIG. 2, consisting of FIGS. 2A-2B, is a diagram illustrating a lathe-type quartz laser fusion welding system optimized for tubular quartz workpieces consistent with an embodiment of the present invention;

FIG. 3 is a functional block diagram illustrating components within the exemplary quartz laser fusion welding system consistent with an embodiment of the present invention;

FIG. 4, consisting of FIGS. 4A-4C, is a series of diagrams illustrating how two glass tubes are concentrically assembled about a longitudinal axis of the tubes and welded together consistent with an embodiment of the present invention;

FIG. 5 is an end-view diagram of the concentrically assembled tubes illustrating how a beam of laser energy may be applied as the tubes are rotated consistent with an embodiment of the present invention;

FIG. 6, consisting of FIGS. 6A-6C, is a series of cross-sectional diagrams of the concentrically assembled tubes illustrating how a beam of laser energy can applied to the tubes to weld and thermally process the tubes using different types of welding systems consistent with an embodiment of the present invention; and

FIG. 7 is a flow chart illustrating typical steps for using laser energy to thermally process concentrically assembled glass tubes using a laser beam consistent with an embodiment of the present invention.

### DETAILED DESCRIPTION

Reference will now be made in detail to an implementation consistent with the present invention as illustrated in the accompanying drawings. Wherever possible, the same reference numbers will be used throughout the drawings and the following description to refer to the same or like parts.

In general, methods and systems consistent with the present invention apply laser energy to two or more concentrically assembled glass tubes, each of which fit in close proximity to the next. The laser energy is applied to a gap between the tubes in order to heat and join the tubes together. Typically, the tubes are fusion welded to each other using such laser energy. Another aspect involves heating a coating layer disposed into the gap between two concentric tubes so that the coating layer is thermally diffused into at least one of the tubes before or as the tubes are joined together.

Those skilled in the art will appreciate that use of the terms “quartz”, “quartz glass”, “vitreous quartz”, “vitrified quartz”, “vitreous silica”, and “vitrified silica” are interchangeable regarding embodiments of the present invention. Additionally, those skilled in the art will appreciate that the term “thermally processing” means any type of glass processing that requires heating, such as cutting, annealing, or welding.

In more detail, when quartz transitions from its solid or “super-cooled liquid” state to the gaseous state, it evaporates or vaporizes. The temperature range between the liquid and gaseous state is somewhere between about 1900 degrees C. and 1970 degrees C. The precise transition temperature varies slightly because of trace elements in the material and environmental conditions. When heated from its solid or super-cooled state to a still super-cooled but very hot, more mobile state, the quartz becomes tacky or thixotropic. Applicants have found that quartz in this state does not cold flow much faster than at lower elevated temperatures and it does not flow (in the sense of sagging) particularly fast, but it does become very sticky.

As the temperature approaches the transition range, the thermal properties of quartz change radically. Below 1900 degrees C., the thermal conductivity curve for quartz is fairly flat and linear (positive). However, at temperatures greater than approximately 1900 degrees C. and below the sublimation point, thermal conductivity starts to increase as a third order function. As the quartz reaches a desired temperature associated with the fusion weldable state, applicants have discovered that it becomes a thermal mirror or a very reflective surface.

The quartz thermal conductivity non-linearly increases with thermal input and increasing temperature. There exists a set of variable boundary layer conditions that thermal input influences. This influence changes the depth of the boundary layer. This depth change results in or causes a dramatic shift in the thermal characteristics (coefficients) of various thermal parameters. The cumulative effect of the radical thermal conductivity change is the cause of the quartz material's abrupt change of state. When its heat capacity is saturated, all of the thermal parameters become non-linear at once, causing abrupt vaporization of the material.

This boundary layer phenomenon is further examined and discussed below. The subsurface layers of the quartz workpiece have, to some depth, a coefficient of absorption which is fixed at “Initial Conditions” (IC) described below in Table 1.

TABLE 1

| | |
|---|---|
| Let the coefficient of thermal absorption of laser | k |
| radiation be: | |
| Let the depth of the sub-surface layer be: | d |
| Let the coefficient of heat capacity be: | c |
| Let the coefficient of reflectance be: | r |
| Let the coefficient of thermal conduction be: | λ |
| Let the density be: | ρ |

As the quartz is heated over a temperature range below 1900 degrees C., k increases but with a shallow slope, and d remains relatively constant and fairly large. However, applicants have found that as the temperature exceeds 1900 degrees C., the slope of k increases at a third-order (cubic) rate until it becomes asymptotic with an increase in thermal conductivity. Simultaneously, the depth of sub-surface penetration d decreases similarly. This causes an increase in the thermal gradient within the quartz object that reduces the bulk thermal conductivity but increases it at the thinning boundary layer on the weldable surface of the object.

As a result, the heat energy is concentrated in the boundary layer at the weldable surface. As this concentration occurs, the coefficient of thermal conductivity increases. These dramatic, non-linear, thermal property changes in the boundary layer create a condition where the energy causes the (finite) weldable surface of the quartz object to become quasi-fluid. As explained above, this condition is at the ragged edge of sublimation. A few more calories of heat and the quartz vaporizes. It is within this temperature range and viscosity region that effective quartz fusion welding can occur. The difficulty in attaining these two conditions simultaneously is that (1) in general, heating is a random, generalized process, and (2) heating is not a precisely controllable parameter. Embodiments of the present invention focus on applying laser energy in order to selectively pierce a quartz object, selectively heat or otherwise thermally process an inner portion of the quartz object and then fusion weld quartz object back together.

For optimal fusion welding, it is important to determine how much heat is needed to raise the quartz object's temperature to just under the vaporization or sublimation point. As described in related U.S. patent application Ser. No. 09/516,937, the amount of energy (energy from a laser, or other heat source) that is required to heat a quartz object to its thermal balance point (thermal-equilibrium) is usually determined prior to applying that energy to the quartz object, which is incorporated by reference. The present application focuses on how the energy is applied to one or more concentrically assembled quartz objects to make an optical preform.

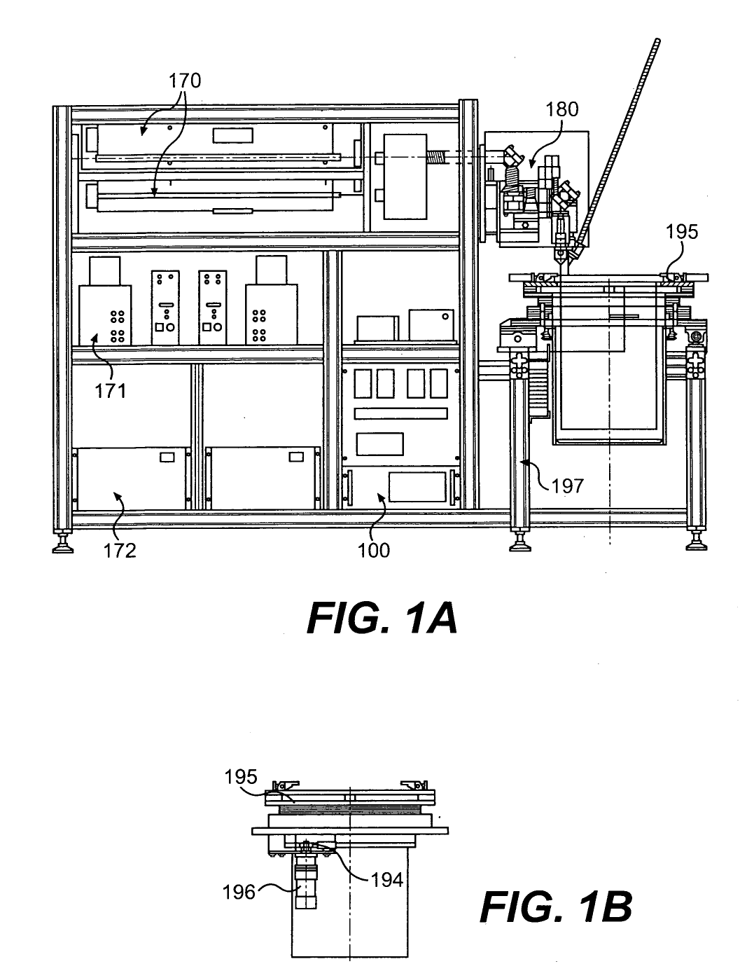

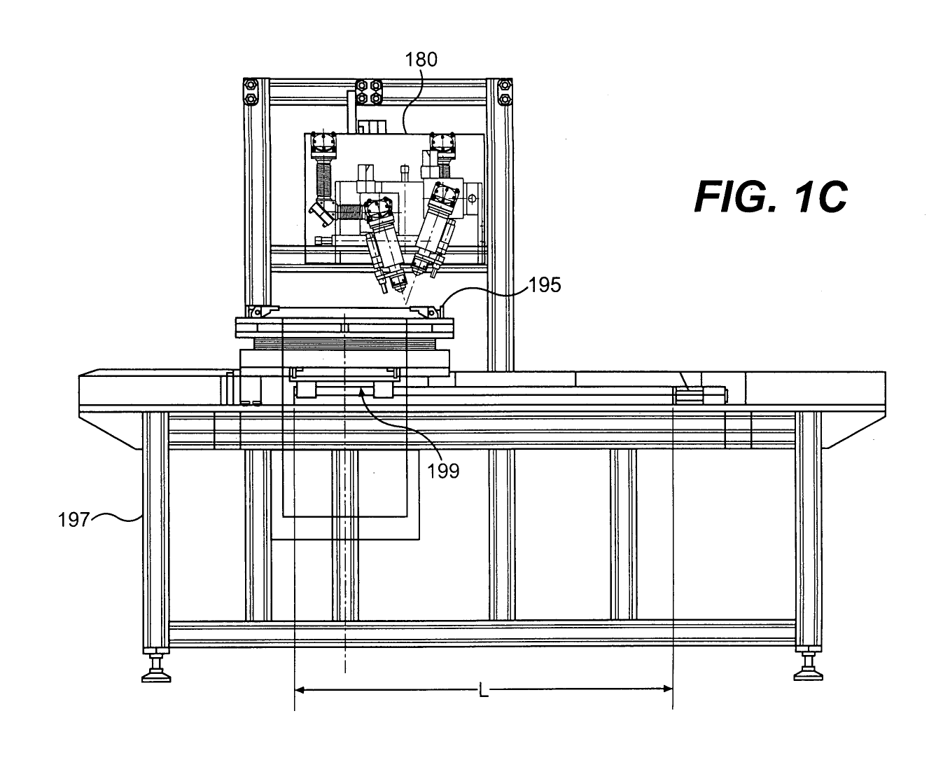

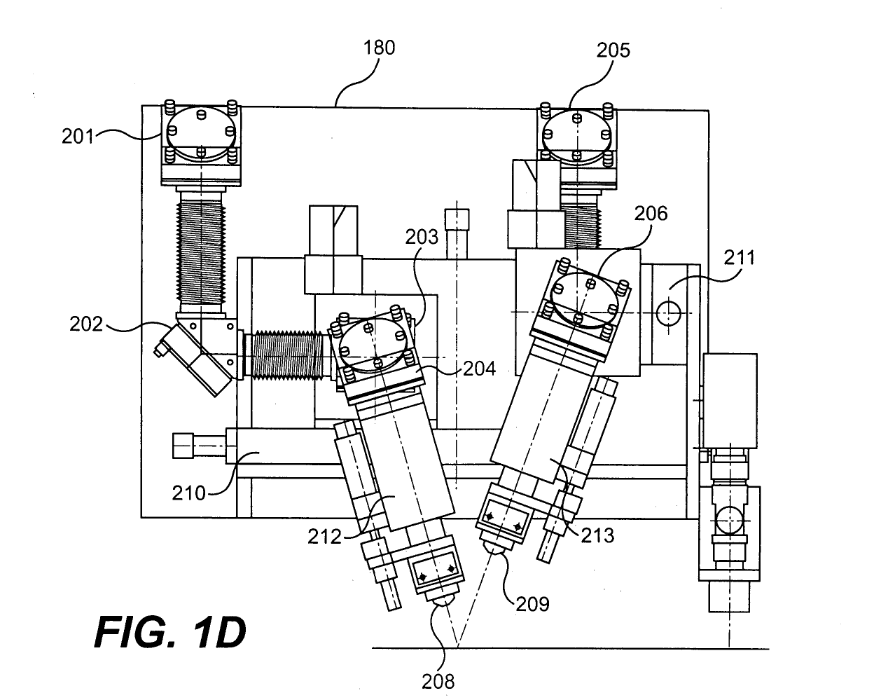

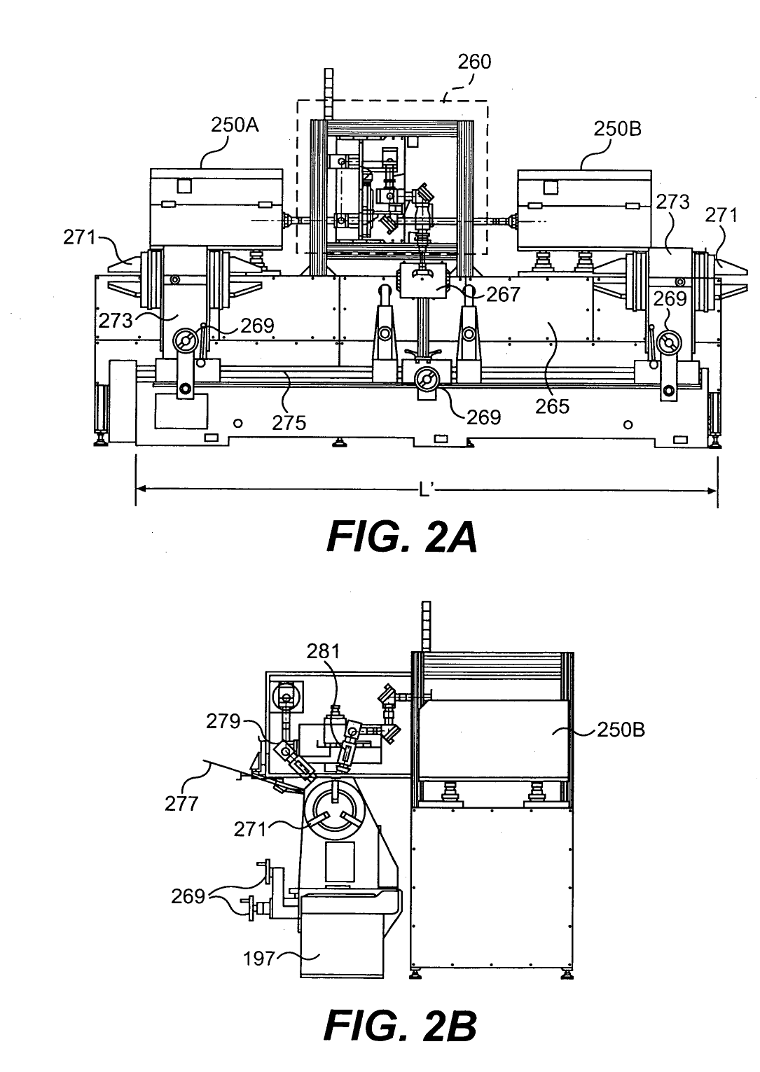

Two types of exemplary quartz fusion welding system are illustrated in FIGS. 1A-D and 2A-2B that are each suitable for applying laser energy to heat or fusion weld quartz objects together consistent with the present invention. The exemplary system illustrated in FIGS. 1A-1D is a general quartz fusion welding system that uses a table and movable working surface to support and move the workpiece as laser energy is applied. However, the exemplary system illustrated in FIGS. 2A-2B is configured with a lathe-type of support for optimal holding and turning of a lengthy tubular workpiece as laser energy is applied.

Referring now to the first example system in FIGS. 1A-1D, the exemplary quartz fusion welding system is a general and flexible laser welding system that includes a laser energy source 170, a movable welding head 180 (more generally referred to as a reflecting head), a movable working surface 195 that supports the quartz workpiece being processed on a table 197 and a computer system (not shown) that controls the system. Each part of this system will now be described in more detail.

Laser energy source 170 is typically one or more lasers, each of which being powered by a power supply and cooled using a refrigeration system. As used within this application, the term “laser energy source” or “laser” should be broadly interpreted to be a lasing element and may include a subsystem having power supplies, refrigeration and terminal optics capable of producing a particular focal length. For example, the laser energy source may be implemented with terminal optics to achieve a focal length of 3.75 inches and a focal spot size of 0.2 mm in diameter. Other focal characteristics are possible with the focal characteristics of movable welding head 180 and the optics dispose therein.

In one embodiment, laser energy source 170 is implemented with multiple lasers, which are combined to produce a composite beam. Those skilled in the art will appreciate that each of these lasers can have the same or different wavelengths, such as 355 nm or 3.5 microns, as part of a laser energy source consistent with an embodiment of the present invention.

In the embodiment (shown in FIG. 1A), laser energy source 170 is implemented as two lasers—an optional preheating laser and another laser for additional processing (e.g., cutting, welding, heating, etc.) of a workpiece. In this embodiment, the preheating laser is a sealed Trumpf Laser Model TLF 1200t CO₂ laser having a predefined wavelength of 10.6 microns and capable of providing up to 1200 Watts of laser power. The second laser is a sealed Trumpf Laser Model TLF 3000t CO₂ laser having a predefined wavelength of 10.6 microns and capable of providing up to 3000 Watts of laser power. The exact power and characteristics of such preheating and processing lasers will vary according to the materials being processed.

When two quartz objects (not shown) are to be fusion welded, the objects are placed in a pre-weld configuration on movable working surface 195. In general, the pre-weld configuration is a desired orientation of each object relative to each other. More specifically, the pre-weld configuration places a surface of one quartz object proximate to and substantially near an opposing surface of the other quartz object. These two surfaces form a gap or channel between the object where the laser energy is to be applied. Those skilled in the art will appreciate that the pre-weld configuration for any quartz objects will vary depending upon the desired joining of the objects.

FIGS. 1B and 1C are diagrams illustrating views of the exemplary working table 197. Referring now to FIG. 1B, a portion of the working table 197 is shown as having movable working surface 195 that is rotatable. The working surface 195 (more generally referred to as a movable support member) supports the glass or quartz workpiece (e.g., a glass tube, two quartz rode, etc.). The working surface 195 also rotates in response to commands or signals from computer 100 to rotational actuator 196 (typically implemented as a DC servo actuator). A timing belt 194 connects the output of the DC motor within rotational actuator 196 to the working surface 195. Thus, working surface 195 rotates the configuration of the supported quartz workpiece(s) on table 197.

FIG. 1C illustrates a side view of table 197. Linear actuator 199 is disposed and configured to move the working surface 195 (and rotational actuators and controls) along length L so that the quartz workpiece or object being processed are linearly moved relative to the welding head 180.

After placement of the quartz objects into the pre-weld configuration, laser energy source 170 provides energy in the form of a laser beam 175 to movable welding head 180 under the control of the computer system (not shown). Movable welding head 180 receives laser beam 175 and directs its energy in a beam 185 to the quartz workpiece in accordance with instructions from computer system (not shown). While it is important to apply laser energy when fusion welding two quartz objects in an embodiment of the present invention, it is desirable that the system have the ability to selectively direct how and where the laser energy is applied relative to the quartz objects themselves. To provide such an ability, the laser energy is applied in a selectable vector (an orientation and magnitude) relative to the quartz objects being fusion welded.

Selecting or changing the vector can be accomplished by moving the laser energy relative to a fixed object or moving the object to be welded relative to a fixed source of laser energy. In the exemplary embodiment, it is preferably accomplished by moving both the quartz objects being welded (by moving and/or rotating the working surface 195 under control of the computer) and by moving the vector from which the laser energy is applied (using actuators to move angled reflection joints within movable welding head 180). In this manner, the system provides an extraordinary degree of freedom by which laser energy can be selectively applied to the quartz object(s).

Movable welding head 180 is used to direct laser energy consistent with an embodiment of the present invention and is shown in more detail in FIG. 1D. Referring now to FIGS. 1D, movable welding head 180 is an example of a reflective conduit for directing the laser energy from laser energy source 170 to the welding zone between the quartz objects being welded. In the exemplary embodiment, movable welding head 180 (generally called a movable head or reflective conduit) directs laser beams using angled reflective surfaces (e.g., mirrors or other types of reflectors) within elbows of a selectively re-configurable arrangement of angled reflection joints.

Furthermore, in the exemplary embodiment where laser energy source 170 includes two lasers, those skilled in the art will appreciate that the first laser projects a beam that is directed through reflection joints 201, 202, 203, 204 before exiting welding head 180 at output 208. Similarly, the second laser projects another beam of laser energy that is directed through another series of angled reflection joints 205, 206, 207 before exiting welding head 180 at another output 290. Those skilled in the art will appreciate that the alignment of the directed laser energy depends upon the orientation of each joint and its relative position to the other joints.

In the exemplary embodiment, welding head 180 is movable in relation to the source of laser energy 170. This allows positioning of the welding head 180 to selectively alter where the laser energy is to be applied while using a fixed or stationary source of laser energy. In more detail, welding head 180 includes a series of actuators capable of moving the angled reflection joints relative to each other. For example, welding head 180 includes actuators (x-axis actuator 210 and y-axis actuator 211), which permit movement of the laser beams directed out of laser. The welding head actuators are typically implemented using an electronically controllable crossed roller slide having a DC motor and an encoder for sensing the movement.

In the second example system in FIGS. 2A-2B, the support structure for the workpiece and the welding head has been optimized to manipulate lengthy tubular workpieces that are rotated as the laser energy is applied. In such a configuration, this optimized second system is commonly referred to as a “butt-welder” given its ability to weld different sized tubes together at their ends with a weld that is perpendicular to the longitudinal axis of the tubes.

As shown in FIG. 2A, this second system includes a warming laser energy source 250A, a welding laser energy source 250B, a movable welding head 260 (more generally referred to as a reflecting head), a lathe-type support structure 265 that supports the quartz workpiece being processed and a computer system (not shown) that controls the system. The lasers 250A, 250B are characteristically similar to the lasers described in the first example. However, the orientation of each output of the welding head 260 (i.e., warming optics 279 and welding optics 281(is altered to orient the laser beams onto a desired point or surface of the tubular workpiece (not shown). In the embodiment shown in FIG. 2B, arming optics 279 and welding optics 281 have multiple axis of motion providing a desired level of flexibility and configurability.

The tubular workpiece may be one or two glass tubes held in place by the lathe-type support structure 265. In more detail, the lathe structure 265 (another example of a movable support member) includes one or more adjustable chucks 271, each of which are disposed on movable lathe stands 273. Each chuck grasps, supports, and holds the tubular glass or quartz workpiece as it is being processed. The lathe stands 273 (commonly called a glass lathe) causes the grasped workpiece to rotate under control of the computer system. Optional muffler 267 is an additional support member that is typically disposed between the lathe stands 273. Muffler 267 is useful to support lengthy tubular workpieces as they are rotated.

The positions of muffler 267 and each lather stand 273 along length L′ on track 275 are selectably manipulated using actuators 269. These positions can be manipulated so that the tubular quartz objects being welded or otherwise processed (i.e., the workpiece) are linearly moved relative to movable welding head 260. In the embodiment in FIG. 2A, the actuators 269 are one or more manually positioned wheels connected to screw-driven positioners (not shown) within each of the lathe stands 273 and the muffler 267. In another embodiment, it is contemplated that the actuators may be electronically or mechanically controlled, using stepper motors or solenoids. Thus, check 271 and lathe 273 are a type of working surface, which supports the workpiece and is movable in a linear and rotational sense to selectively position the workpiece relative to the movable welding head 260.

In yet another embodiment (not shown), it is contemplated that the laser energy source itself can be selectively moved relative to the glass object. This may be accomplished via electronically controllable actuators coupled to the laser energy source, a controlled robotic positioning system coupled to the source or any other mechanical structure that can be used to provide multiple degrees of freedom and positioning of the source. It is contemplated that such actuators or other positioning devices may be used to orient and position the laser energy source such that the laser beam exits the source and is applied directly at a desired point on the glass object. One skilled in the art will appreciate that this alternative embodiment alleviates the need for a reflective conduit (e.g., welding head 180) which indirectly (via one or more reflective devices) provides and selectively directs the laser beam onto the desired point on the glass object.

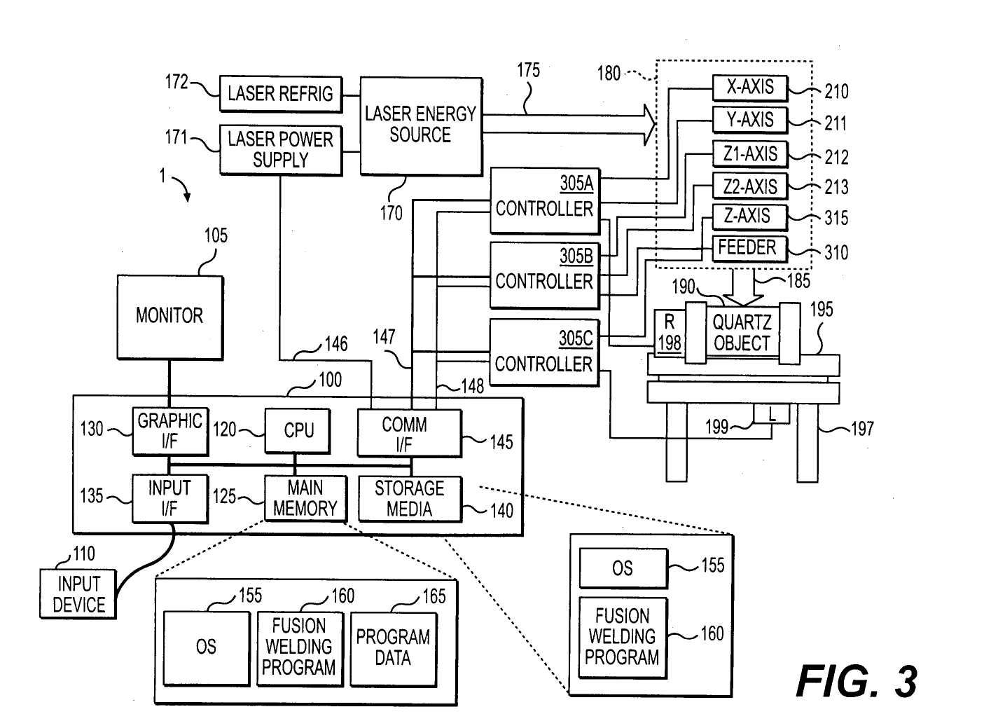

FIG. 3 is a functional block diagram illustrating components within an exemplary quartz laser fusion welding system consistent with an embodiment of the present invention. While FIG. 3 shows a computer system and controllers interacting with components from the example welding system shown in FIGS. 1A-1D, those skilled in the art will appreciate that the same computer and controllers may be used with similar components from the alternative example welding system shown in FIGS. 2A-2B.

Referring now to FIG. 3, computer system 100 sets up and controls laser energy source 170, movable welding head 180, and movable working surface 195 (implemented as the lathe and chuck in FIGS. 2A-2B) in a precise and coordinated manner during thermal processing (e.g., fusion welding, selective heating, or cutting open) of the quartz objects on working surface 195. The computer system 100 typically turns on laser energy source 170 for discrete periods of time providing a selective energy level for the resulting beam. The computer system 100 also controls the positioning of movable welding head 180 and movable working surface 195 relative to the quartz objects being processed so that surfaces on the objects can moved and be easily processed (e.g., heated, welded, cut open, re-fused, etc.) in an automated fashion via contol signals to the appropriate actuator. As discussed and shown in FIGS. 1A-1D, movable working surface 195 typically includes actuators allowing it to move along a longitudinal axis (preferably the x-axis) as well as rotate relative to the movable welding head 180.

Looking at computer system 100 in more detail, it contains a processor (CPU) 120, main memory 125, computer-readable storage media 140, a graphics interface (Graphic I/F) 130, an input interface (Input I/F) 135 and a communications interface (Comm I/F) 145, each of which are electronically coupled to the other parts of computer system 100. In the exemplary embodiment, computer system 100 is implemented using an Intel PENTIUM III® microprocessor (as CPU 120) with 128 Mbytes of RAM (as main memory 125). Computer-readable storage media 140 is preferably implemented as a hard disk drive that maintains files, such as operating system 155 and fusion welding program 160, in secondary storage separate from main memory 125. One skilled in the art will appreciate that other computer-readable media may include secondary storage devices (e.g., floppy disks, optical disks, and CD-ROM); a carrier wave received from a data network (such as the global Internet); or other forms of ROM or RAM.

Graphics interface 130, preferably implemented using a graphics interface card from 3Dfx, Inc. headquartered in Richardson, Tex., is connected to monitor 105 for displaying information (such as prompt messages) to a user. Input interface 135 is connected to an input device 110 and can be used to receive data from a user. In the exemplary embodiment, input device 110 is a keyboard and mouse but those skilled in the art will appreciate that other types of input devices (such as a trackball, pointer, tablet, touchscreen or any other kind of device capable of entering data into computer system 100) can be used with embodiments of the present invention.

Communications interface 145 electronically couples computer system 100 (including processor 120) to other parts of the quartz fusion welding system 1 to facilitate communication with and control over those other parts. Communication interface 145 includes a connection 146 (preferably using a conventional I/O controller card or interface) to laser energy source 170 used to setup and control laser energy source 170. In the exemplary embodiment, this connection 146 is to laser power supply 171. Those skilled in the art will recognize other ways in which to connect computer system 100 with other parts of fusion welding system 1, such as through conventional IEEE-488 or GPIB instrumentation connections.

In the exemplary embodiment of the present invention, communication interface 145 also includes an Ethernet network interface 147 and an RS-232 interface 148 for connecting to hardware that implement control systems within movable welding head 180 and movable working surface 195. The hardware implementing such control systems includes controllers 305A, 305B, and 305C. Each controller 305A-C (preferably implemented using Parker 6K4 Controllers) is controlled by computer system 100 via the RS-232 connection and the Ethernet network connection. Communication with the control system hardware through the Ethernet network interface 147 uses conventional TCP/IP protocol. Communication with the control system hardware using the RS-232 interface 148 is typically for troubleshooting and setup. Looking at the hardware in more detail, controllers 305A-305C control the actuators necessary to selectively apply the laser energy to a surface of a quartz object supported by the chuck on the lathe. Specifically, controller 305A is configured to provide drive signals to actuators on the welding head, and rotational (“R”) actuator 198. Controller 305B is typically configured to provide drive signals to other actuators on the welding head and a fill rod feeder (“Feeder”) actuator 310 attached to the movable welding head 180. Similarly, controller 305C is configured to provide drive signals to the rest of the welding head actuators and linear (“L”) actuator 199 for linear movement of the working surface 195 of table 197.

Each of the drive signals are preferably amplified by amplifiers (not shown) before sending the signals to control a motor (not shown) within these actuators. Each of the actuators also preferably includes an encoder that provides an encoder signal that is read by controllers 305A-C.

Once computer system 100 is booted up, main memory 125 contains an operating system 155, one or more application program modules (such as fusion welding program 160), and program data 165. In the exemplary embodiment, operating system 155 is the WINDOWS NT™ operating system created and distributed by Microsoft Corporation of Redmond, Wash. While the WINDOWS NT™ operating system is used in the exemplary embodiment, those skilled in the art will recognize that the present invention is not limited to that operating system. For additional information on the WINDOWS NT™ operating system, there are numerous references on the subject that are readily available from Microsoft Corporation and from other publishers.

Fusion Welding Process

In the context of the above-described system, fusion welding program 160 causes a specific amount of laser energy to be applied to the quartz objects that are in the pre-weld configuration in a controlled manner. This is typically accomplished by manipulating the movable welding head 180 and movable working surface 195. The laser energy is advantageously and uniformly applied to the object surfaces being fusion welded.

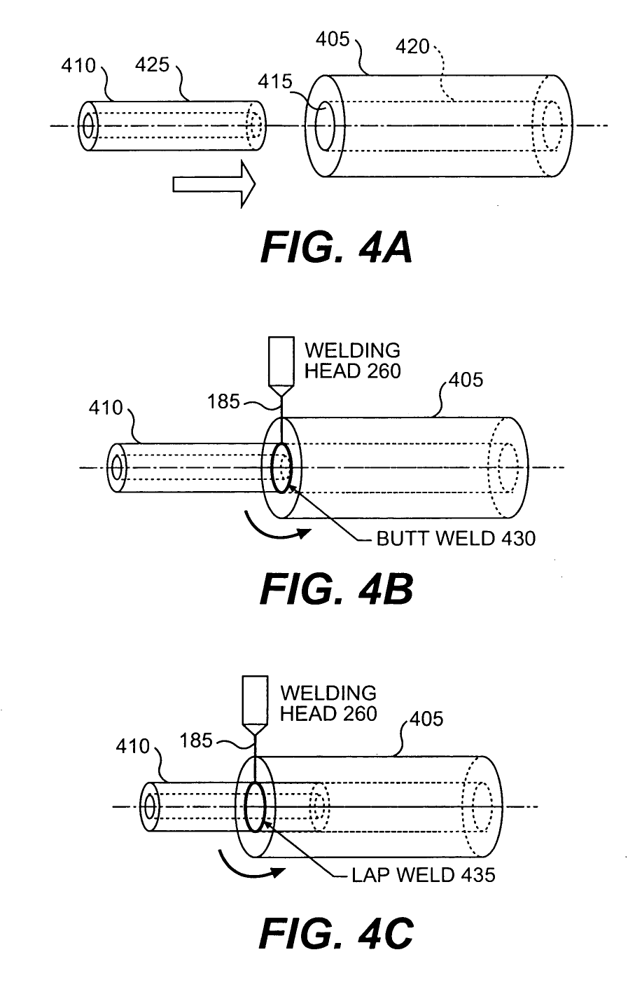

In the exemplary embodiment and as part of setting up to join two or more quartz tubes together to form an optical preform using the laser energy, the quartz tubes are placed in their pre-weld concentric configuration. FIGS. 4A-4C shows how two exemplary glass tubes are concentrically assembled about a longitudinal axis of the tubes and can be welded together consistent with an embodiment of the present invention.

Referring now to FIG. 4A, an outer glass tube 405 is illustrated having a hollow interior cylindrical section 415 defined by an inner surface 420 (also called the inside diameter surface of tube 405).

In FIG. 4B, an inner glass tube 410 is placed with its end next to the end of the outer glass tube 405. In this end-to-end configuration, a butt weld 430 may be created by applying the laser 185 to the intersection of the tubes as the tubes are rotated. In an example using the exemplary butt welding system from FIGS. 2A-2B, each of the tubes 405, 410 may be placed within respective chucks 271. As lathe 273 turns the tubes in unison, laser energy may be applied in a rotational fashion to fusion weld the tubes end-to-end. This is especially useful when tube 410 cannot fit within tube 405.

In another example, tube 410 is placed within the hollow interior section 415 of outer tube 405 so that inner glass tube 410 and outer tube 405 are in a concentric configuration as shown in FIG. 4C. The inner glass tube 410 has an outer surface 425 that is generally considered to be proximate to the inner surface 420 of the outer glass tube 405 when assembled. Thus, the inner surface 420 and outer surface 425 are considered to define a gap between the tubes when the tubes are assembled. Typically, such a gap is 0.5 millimeter or less. Again, using the exemplary butt-welding system from FIGS. 2A-2B, the lathe 273 may turn the tubes while laser energy is applied where the inner tube 410 exits from the outer tube 405, forming a lap weld 435 at the gap.

In the exemplary embodiment where the tubes are cylindrical, the gap is cylindrically shaped. However, it is contemplated that the outer surface 425 and inner surface 420 may be other shapes. In other words, the shape of the gap can be of a variable geometry as long as the inner surface 420 and the outer surface 425 resemble each other and a laser beam can be reflected down the gap from one end of the tubes. Those skilled in the art will appreciate that the precise shape will depend upon the optical fiber designer's needs for the light-carrying part of the fiber.

Furthermore, inner glass tube 410 may be hollow or solid. When the inner glass tube (such as tube 410 illustrated in FIGS. 4A-4C) is hollow, those skilled in the art will appreciate that further heating will be required after fusing the tubes together in order to collapse the concentric tubes down and into an optical preform. However, such a collapsing post-processing step is unnecessary when inner glass tube 410 is implemented with a solid glass rod.

While in their pre-weld concentrically assembled configuration, the tubes are usually soaked at an initial preheating temperature to help avoid rapid changes in temperature that may induce stress cracks within the resulting fusion weld. In the exemplary embodiment, the preheating temperature is typically between 500 and 700 degrees C. and is typically applied with the preheating laser shown in FIG. 1A or warming laser 250A in FIG. 2A. Other embodiments may include no preheating or may involve applying energy for such preheating using the beam of laser energy itself or energy from other heat sources, such as a hydrogen-oxygen flame.

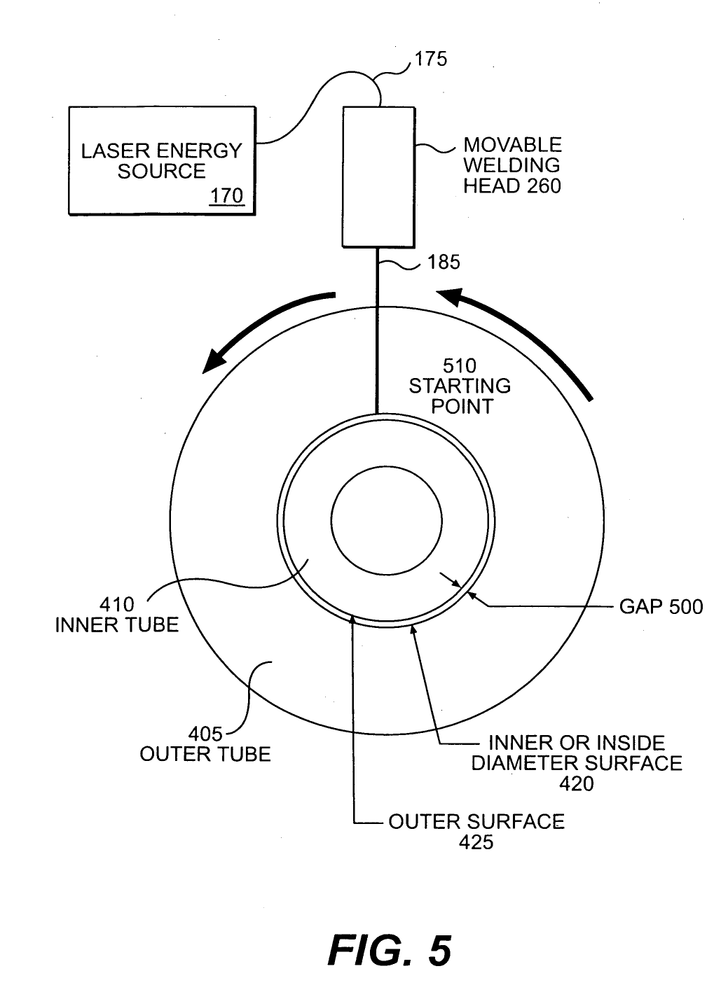

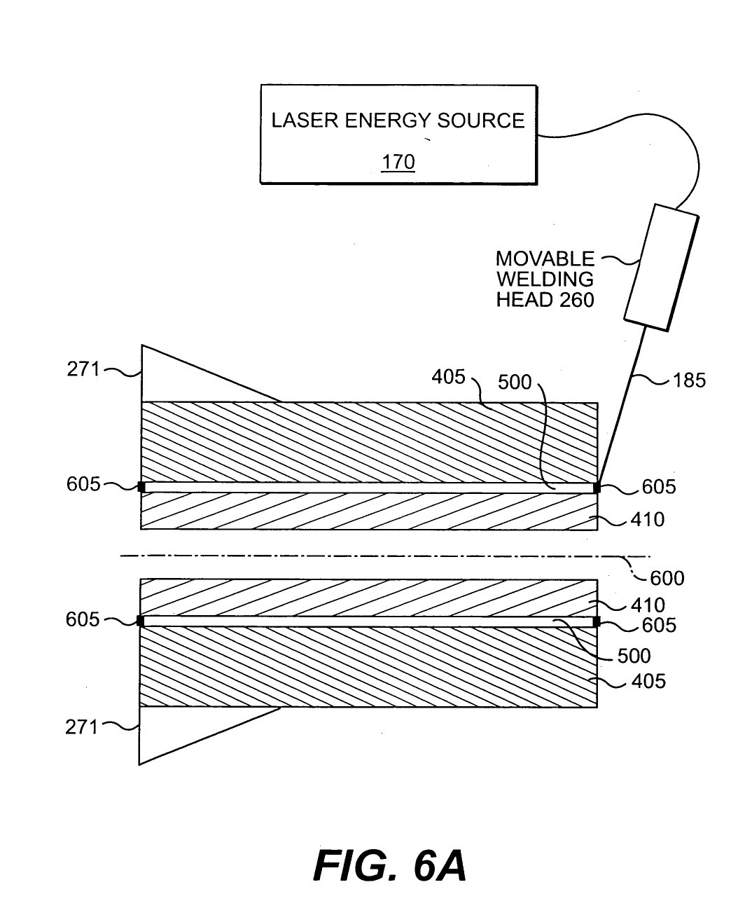

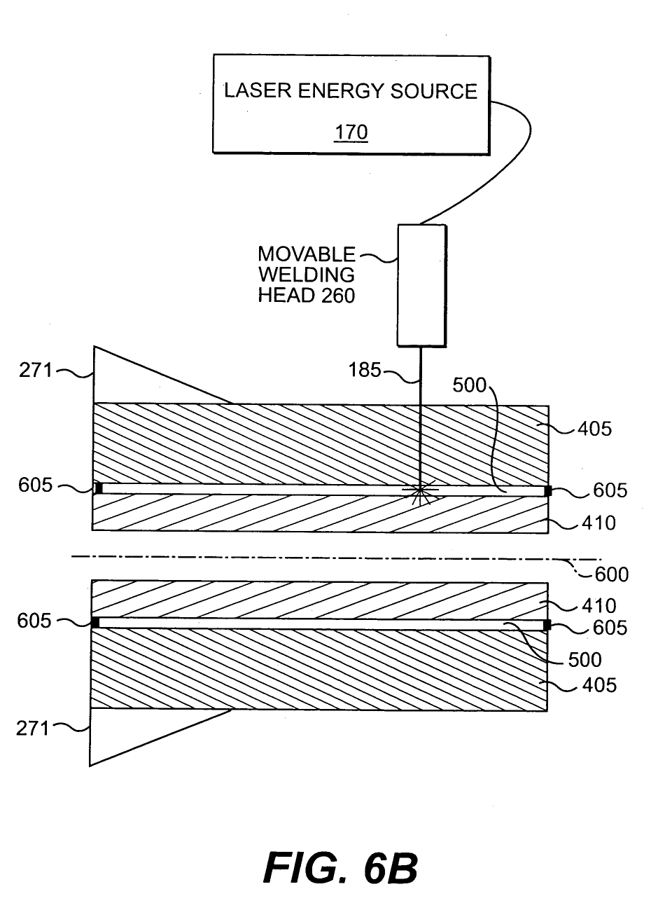

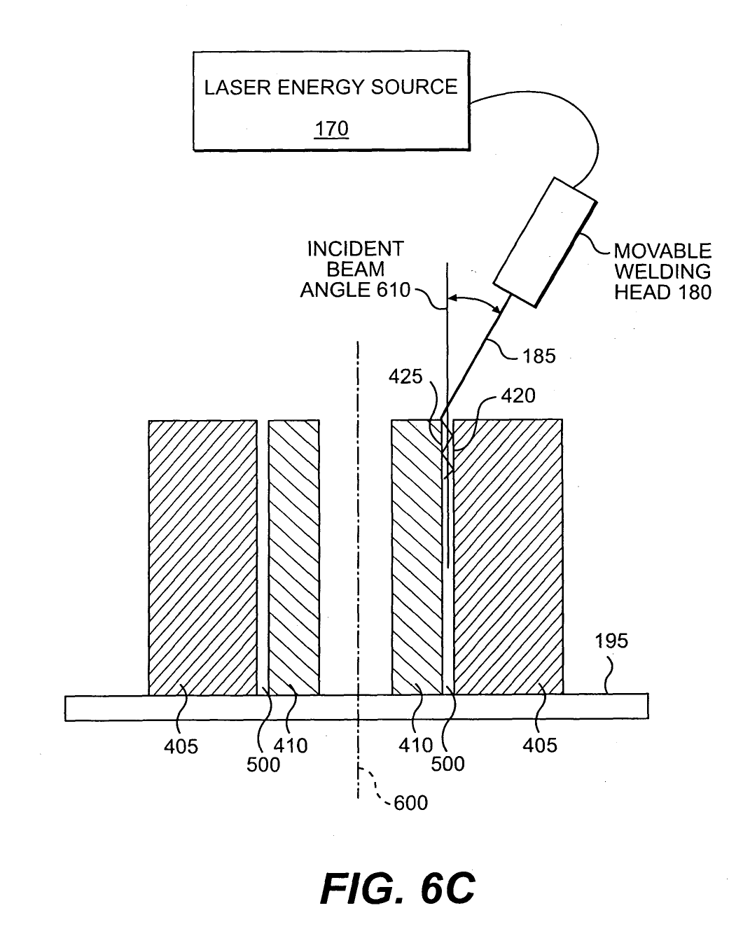

Once preheated, fusion welding program 160 is used to control how the laser energy is applied to assembled concentric tubes. In general, the welding program positions and aligns the laser beam so that it is applied and reflected down into a gap between the assembled concentric quartz tubes as the tubes are fusion welded together to form an optical preform. FIGS. 5 and 6A-6C show various views of how laser energy is directly applied and used to join the concentrically assembled tubes to form the optical preform. Essentially, FIG. 5 shows an end view of two concentrically assembled tubes as the gap between them is sealed by applying the laser beam to the gap. FIGS

Referring now to FIG. 5, a view of the end of the concentrically assembled tubes is illustrated. Inner tube 410 is shown disposed within the hollow interior section 415 of outer tube 405. This results in a gap 500 between the inner surface (also conventionally referred to as an inside diameter (ID) surface) 420 and the outer surface 425. In order to join the two tubes 405, 410 together, a beam of laser energy 185 is positioned to hit a starting point 510 as the tubes are rotated or moved relative to the beam in unison.

There are many different ways in which the laser beam and/or the glass object may be moved relative to each other in order to alter where laser energy is applied on or within the glass object. For purposes of this patent application, reference to “movement relative to” the laser and glass object should be interpreted to mean that either the laser or the glass object or both are actually placed in motion with respect to each other. The important aspect is that the relative orientation of the laser beam and glass object is changed during such movement regardless of which (the beam and/or the object) is actually moved.

If the gap is non-cylindrically shaped, such movement may involve translational or linear movement instead of or in addition to the rotational movement described above.

In another embodiment of the present invention, the laser energy is optimally applied within gap 500 using multiple laser beams. Using multiple laser beams is often useful and desired when the area to be heated is relatively thick and there is a need to create a lengthy heating zone (also called a laser beam focal field). The beams from each laser are combined or bundled together coaxially or collaterally (as shown in commonly owned and concurrently filed U.S. patent application Ser. No. __/___,___, which is hereby incorporated by reference) to form a composite laser beam. Within the composite beam, selective focusing each of the laser beams can also alter how the energy is applied to the object to achieve such a lengthy and flexible heating zone. Changing the depth of focus for each beam allows for adjustably configuring the size of the heating zone produced by the beams. In other words, as the depth of focus becomes shallower or smaller, the angle of focus becomes higher and the faster the laser energy from the beam converges to and diverges from its focal point. Thus, the applicants have found that it may be advantageous to combine the laser beams and produce the composite beam using different focal points, different wavelengths, and/or different energy levels because the differing characteristics of the two beams produce a flexible zone of highly concentrated energy.

As such, it can be understood that beam 185 can be used to seal the gap (FIG. 6A), heat a reactant gas disposed within the gap to deposit a coating within the gap (FIG. 6B) and then heat the deposited coating within the gap (FIG. 6B) or, depending upon the configuration of workpiece, may be reflected down the gap to fusion weld the tubes together (FIG. 6C) as part of forming an optical preform. Referring now to FIG. 6A, outer tube 405 is disposed about the longitudinal axis 600 of inner tube 410 in a concentric configuration. In this horizontally oriented configuration of the tubes, laser beam 185 may be directed to the gap 500 (more generally called a welding zone) between the tubes at an angle that is nearly normal to the longitudinal axis 600. In the exemplary embodiment, this angle is approximately 0-10 degrees off normal so that the beam is angled to hit the gap edges as the tubes are rotated. In this manner, a welded seal 605 is formed that seals the gap between tubes 405 and 410.

Those skilled in the art will appreciate that a reactant gas (such as metal halides and oxygen) may be disposed within the gap as it is sealed. Such gas is conventionally used as part of vapor deposition techniques (e.g., MCVD) in quartz glass when making optical fiber preforms. As the reactant gas (metal halides and oxygen) is heated, its reacts to deposit a soot or dopant material on the inside diameter surface of the tube that forms a sintered glass having a desired refractive gradient characteristic. Heating of such gas may be accomplished via the laser beam 185 as shown in FIG. 6B. A more detailed description of how a laser may be used to deposit dopant materials and heat them to cause thermal migration of the dopant into the glass tube is described in co-pending U.S. application Ser. No. ______ “METHOD AND APPARATUS FOR CREATING A REFLECTIVE GRADIENT IN GLASS USING LASER ENERGY”, which is commonly owned and hereby incorporated by reference.

FIGS. 6A-6B show the concentrically assembled tubes in a horizontal configuration that is optimally held and manipulated using lathe 273 and chuck 271 as shown in FIG. 2A. In this situation, the tubes 410, 405 may be easily rotated despite their length. When vertically configured as shown in FIG. 6C, the tubes may also be manipulated using movable working surface 195 from FIG 1A. In such a vertical configuration as shown in FIG. 6C, the laser beam 185 can be reflected down the gap 500 to fusion weld the tubes together as part of forming an optical preform. In more detail, movable welding head 180 operates to align the energy and direct laser beam 185 to outer surface 435 of the inner tube 410. This is typically accomplished by orienting the laser beam at an incident beam angle 605 of 0-10 degrees from the centerline of the gap 500. While the exemplary environment typically uses a 0-10 degree incident beam angle 605 when launching laser beam 185 into gap 500, those skilled in the art will realize that any angle would suffice as long as the laser energy is reflected and distributed down the gap 500.

As the outer surface 425 absorbs the incident laser energy from laser beam 185 and the surface is increasingly heated, the heated portion of outer surface 425 becomes shiny and reflective. In other words, as the heated portion of outer surface 425 approaches a fusion weldable condition, that portion of outer surface 425 reaches a reflective state. In this reflective state, outer surface 425 bounces or transfers the energy of the laser beam 185 to the opposing surface of gap 500, namely inner surface 420. As a result, the opposing inner surface 420 also reaches the reflective state and laser beam 185 is repeatedly reflected down the length of gap 500 heating surfaces 425 and 420 to a substantially uniform or even distribution. Further heating occurs when the beam is rotated or moved about the longitudinal axis of the tubes to heat another part of the gap 500. In this manner, the surfaces deep within gap 500 can be precisely and substantially evenly heated. Once the surfaces to be welded reach the reflective state and distribute the heat, the surfaces reach a fusion weldable condition so that the surfaces will molecularly fuse together to form a fusion weld. Those skilled in the art will appreciate that depending upon the exact width of the gap, quartz filler material may be added within gap 500 as the beam 185 fusion welds the inner tube 410 to the outer tube 405.

In another embodiment of the present invention, a coating layer or dopant layer is is already disposed within gap 500. The coating layer is typically a raw metal coating material, including but not limited to metals, metal halides and/or rare earth elements. The layer has normally been applied to outer surface 425 of the inner tube 410 prior to assembly or as part of the assembly process. Alternatively, it is contemplated that the layer has been applied to inner surface 420 of the outer tube 405 prior to assembly or as part of the assembly process.

The laser beam is applied to the coating layer disposed within the gap. In this exemplary embodiment, application of the laser beam is accomplished by applying the laser beam against the coating layer and the opposing surface of glass within the gap 500. In this manner, the beam selectively heats the coating layer as the beam is reflected down the gap. Selectively controlling the amount of energy applied via the laser beam and the amount of time the laser beam is applied to a specific point allows for control of the depth of the thermally induced dopant diffusion. In the exemplary embodiment, selective heating of the coating layer is controlled by varying parameters of the beam (e.g., energy levels, modulation characteristics, creating different characteristics of each laser beam as part of a composite beam, etc.) and by moving the beam on and off a particular point on the coating layer over a given period of time. Thus, heating a particular point of the coating layer for a predetermined amount of time causes controlled thermal diffusion of the coating layer into at least the tube in direct contact with the coating layer. One skilled in the art will quickly appreciate that use of a movable working surface (e.g., surface 195) and a directable laser energy source (e.g., laser energy source 170 in combination with movable welding head 180 or a movable laser energy source (not shown)) permit the optical fiber designer a degree of freedom and flexibility not previously available when designing refractive core and cladding structures which may have desired light carrying benefits for communication and sensor applications.

Once the coating layer is diffused at a desired depth into at least one of the tubes, the tubes may be joined by fusion welding them together as described above. As further heating or later fusion of the tube having the coating layer with the other tube occurs, additional diffusion of the coating layer may occur. Those skilled in the art will appreciate that the actual time for applying the laser beam can be experimentally determined based on the thickness of the coating material being fused, the energy of the laser, and the desired migration profile. Other factors used to determine how long the laser should be hovering over a particular point when diffusing the coating into the tube have to do with the temperatures at which the diffusion or fusion takes place. Those skilled in the art will appreciate that different types of dopant materials will diffuse at different rates into quartz.

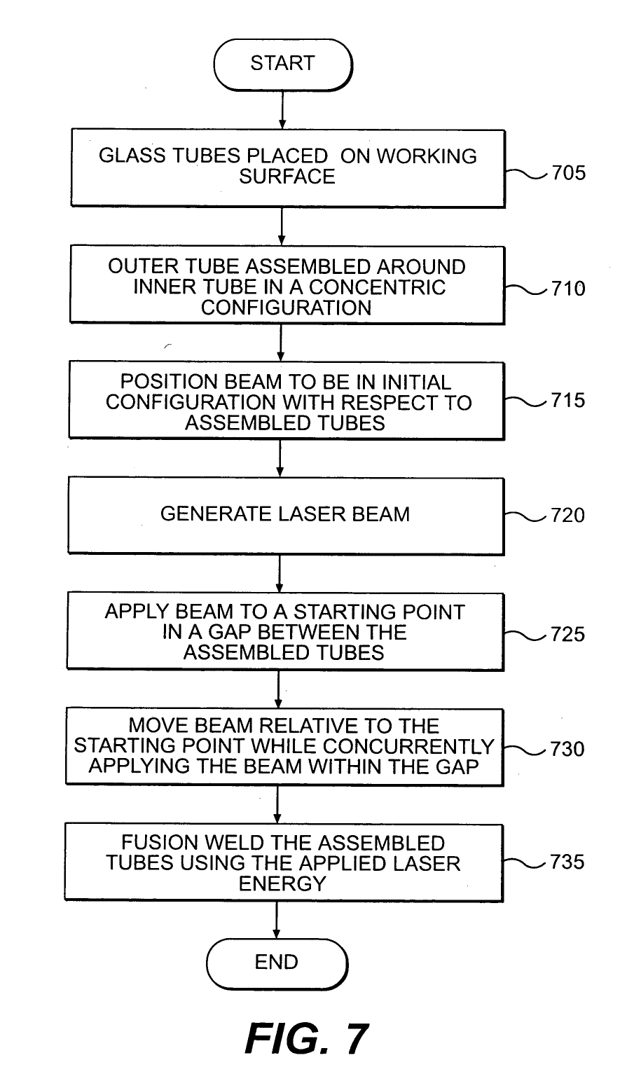

FIG. 7 is a flow chart illustrating exemplary steps for concentrically forming an optical preform using a beam of laser energy that is consistent with an embodiment of the present invention. Referring now to FIG. 7, method 700 begins at step 705 where at least two glass tubes are placed on a working surface. The tubes fit together concentrically with an inner-most tube having an outer surface that is placed proximate to the inner surface of the next larger tube. In the exemplary embodiment, the inner tube may be implemented as a solid glass rod while the outer tube may be a hollow glass tube that can tightly fit around the inner tube leaving a small gap. At step 710, the outer tube is assembled around the inner tube in a concentric configuration. Assembly normally involves the insertion of the inner tube within the hollow section of the outer tube so that the outer tube concentrically surrounds the inner tube. In the exemplary embodiment, the concentric configuration of these tubes is illustrated in FIGS. 5 and 6A-6C.

Steps 715-725 generally involve directing the laser beam into a gap between the glass tubes that will then fuse the tubes together to form the optical preform. More particularly stated, the laser beam is positioned in an initial configuration at step 715 with respect to the assembled tubes. In the exemplary embodiment, beam 185 is positioned relative to concentrically assembled tubes 405, 410 by moving the working surface 195 that supports the tubes and/or by actuating the movable welding head 180 to move the orientation of the beam 185 so that it hits a starting point within the gap between the tubes. The initial configuration prescribes an arbitrary rotational starting angle and an incident beam angle (illustrated as angle 610 in the example shown in FIG. 6C).

At step 720, the beam of laser energy is generated. In the exemplary embodiment, beam 185 is a single laser beam. In an alternative embodiment, laser beams from multiple laser are combined or bundled together coaxially or collaterally to form a composite laser beam as beam 185. The applicants have found that it may be advantageous to combine the laser beams and produce the composite beam using different focal points, different wavelengths, and/or different energy levels. These differing characteristics of the two beams produce a flexible zone of highly concentrated energy. In an example using two laser beams, those skilled in the art will appreciate that a first laser provides a laser beam F1 to a beam expander, which delays the phase of the F1 wave front. This creates a phase-delayed wave front that is coupled to a combiner/reflector, which then joins the phase-delayed wave front with a flat wave front beam (also called the F2 wave front), which is provided by the second laser, to produce the integrated or composite laser beam. Furthermore, lenses may be used to selectively focus the beams helping to provide the ability to create a zone of high energy concentration (also called the heating zone or focal zone) between the focus points of the F1 and F2 wavefronts.

At step 725, the beam is applied to the starting point in the gap. In this manner, the laser energy is directly applied to the surfaces within the gap as the laser beam is bounced or reflected down into the gap. If the laser energy is being used to seal the gap 500 as shown in FIG. 6A, the beam 185 is typically applied to the edges of the tubes as filler glass material is provided. As the glass material and the glass at the edges of the tubes reach a fusion weldable state, weld 605 is formed. At step 730, the beam is moved relative to the starting point while the beam is concurrently applied within the gap. In the exemplary embodiment of FIG. 6C, such movement rotates the beam so that the laser beam radiation is directly applied and distributed to the rest of the gap 500 so that the surfaces within gap 500 are heated.

At step 735, the inner surface of the outer or external tube and the outer surface of the inner tube have been heated in a controlled manner by the laser beam to a point where these surfaces become fusion welded to each other. In this way, the tubes each form concentric parts of the resulting optical preform.

In addition to simply fusion welding two concentric tubes together, there can be a coating layer disposed within the gap as well. Examples of such a coating or dopant layer include metals, metal halides, and rare earth elements. Typically, the laser beam is applied to the coating as it is disposed in the gap. While applying the beam, the beam is moved to selectively heat the coating and cause thermal diffusion of the coating into at least one of the concentric tubes. This advantageously provides at least one of the tubes with a refractive characteristic related to the diffused dopent material from the coating. Once the coating has been diffused within the gap, the assembled tubes can be fusion welded as recited in step 735 using the applied laser energy.

Those skilled in the art will appreciate that embodiments consistent with the present invention may be implemented in a variety of technologies and that the foregoing description of an implementation of the invention has been presented for purposes of illustration and description. It is not exhaustive and does not limit the invention to the precise form disclosed. Modifications and variations are possible in light of the above teachings or may be acquired from practicing of the invention.

While the above description encompasses one embodiment of the present invention, the scope of the invention is defined by the claims and their equivalents.

What is claimed is:

1. A method for concentrically forming an optical preform using a beam of laser energy, comprising the steps of:
placing a first glass tube around a second glass tube in a concentric configuration, the first glass tube having an inner surface and the second glass tube having an outer surface that is placed proximate to the inner surface; and
directing the beam of laser energy between the inner surface of the first glass tube and the outer surface of the second glass tube to fuse the first glass tube to the second glass tube, thus forming the optical preform.

2. The method of claim 1, wherein the directing step further comprises:
positioning the beam of laser energy in an initial orientation with respect to the first glass tube and the second glass tube; and
applying the beam of laser energy between the inner surface and the outer surface.

3. The method of claim 2, wherein the directing step further comprises moving the first glass tube and the second glass tube relative to the beam of laser energy.

4. The method of claim 3, wherein the moving step further comprises rotating the first glass tube and the second glass tube relative to the beam of laser energy causing the beam of laser energy to selectively heat the inner surface and the outer surface as the beam of laser energy reflects between the inner surface and the outer surface.

5. The method of claim 4, wherein the moving step further comprises rotating the first glass tube and the second glass tube about a longitudinal axis of the first glass tube while concurrently reflecting the beam of laser energy between the inner surface and the outer surface causing the inner surface and the outer surface to fusion weld together.

6. The method of claim 1, wherein second glass tube has a coating layer disposed on the outer surface; and
wherein the directing step further comprises
applying the beam of laser energy to the coating layer,
selectively heating the coating layer using the beam of laser energy causing diffusion of the coating layer into at least the second glass tube, and
fusion welding the first glass tube and the second glass tube together using the beam of laser energy to form the optical preform.

7. A method for concentrically forming an optical preform using a beam of laser energy, comprising the steps of:
assembling at least one hollow glass tube concentrically around a solid glass rod, the hollow glass tube having an inside diameter (ID) surface and the solid glass rod having an outer surface, the ID surface and the outer surface defining a cylindrical gap between the hollow glass tube and the solid glass rod;
positioning the beam of laser energy in an initial configuration with respect to the concentrically assembled tube and rod;
generating a beam of laser energy within a laser energy source;
applying the beam of laser energy to a starting point within the cylindrical gap; and
moving the beam of laser energy relative to the starting point as the applied beam is used to join the ID surface to the outer surface to form the optical preform.

8. The method of claim 7, wherein the initial configuration prescribes an incident beam angle for the beam of laser energy.

9. The method of claim 8, wherein the moving step further comprises rotating the concentrically assembled tube and rod around the solid glass rod causing the beam of laser energy to selectively heat the ID surface and the outer surface.

10. The method of claim 9, wherein the rotating step further comprises rotating the concentrically assembled tube and rod about a longitudinal axis of the solid glass rod while concurrently applying the beam of laser energy to each of the ID surface and the outer surface causing the inner surface and the outer surface to fusion weld together.

11. The method of claim 7, wherein the solid glass rod has a coating layer disposed on the outer surface and wherein the applying step further comprises applying the beam of laser energy to the coating layer at the starting point; and
wherein the moving step further comprises moving the beam of laser energy relative to the starting point as the applied beam causes thermal diffusion of the coating layer into at least the solid glass rod.

12. The method of claim 11 further comprising fusion welding the hollow glass tube and the solid glass rod together using the beam of laser energy to form the optical preform.

13. An apparatus for concentrically forming an optical preform using a beam of laser energy, comprising:
a processor;
a communications interface coupled to the processor;
a laser energy source in communication with the processor via the communications interface, the laser energy source being capable of selectively providing a beam of laser energy in response to a first signal from the processor;
a movable support member in communication with the processor via the communications interface, the movable support member for supporting a hollow glass tube concentrically assembled around a solid glass rod having a longitudinal axis, the hollow glass tube having an inside diameter (ID) surface, the solid glass rod having an outer surface that is proximate to the ID surface of the hollow glass tube, the ID surface and the outer surface defining a cylindrical gap between the hollow glass tube and the solid glass rod, the movable support member being capable of moving the tube and rod relative to the beam of laser energy in response to a second signal from the processor; and
a reflective conduit in communication with the processor via the communications interface, the reflective conduit being configured to receive the beam of laser energy from the laser energy source and to adjustably provide the beam of laser energy down into the cylindrical gap in response to a third signal from the processor, thereby causing the hollow glass tube and the solid glass rod to be fusion welded together to form the optical preform.

14. The apparatus of claim 13, wherein the reflective conduit is further operative to provide the beam of laser energy at a predetermined incident beam angle into the cylindrical gap in response to the third signal from the processor.

15. The apparatus of claim 13, wherein the movable support member further comprises at least one actuator for moving the movable support member as the beam of laser energy is applied to the cylindrical gap.

16. The apparatus of claim 15, wherein the at least one actuator causes a rotational shift between the beam of laser energy and the movable support member.

17. The apparatus of claim 16, wherein the movable support member is a lathe device having an adjustable chuck for supporting the concentrically assembled tube and rod.

18. The apparatus of claim 15, wherein the at least one actuator rotates the hollow glass tube and the solid glass rod about the longitudinal axis as the beam of laser energy is concurrently applied to the cylindrical gap in response to the second signal from the processor.

19. The apparatus of claim 13, wherein the reflective conduit is further configured to apply the laser beam to a coating disposed between the tube and rod as the processor causes the movable support member to rotate the tube and rod together around the longitudinal axis of the rod, thereby causing the tube, the coating and the rod to be joined together to form the optical preform.

20. A method for concentrically forming an optical preform using a beam of laser energy, comprising:
applying the beam of laser energy to a coating layer disposed between an inner surface of a first glass tube and an outer surface of a second glass tube, the first glass tube being concentrically assembled around the second glass tube; and
selectively heating the coating layer using the beam of laser energy causing diffusion of the coating layer to create the optical preform.

21. The method of claim 20, wherein the selective heating step further comprises welding the coating layer, the inner surface of the first glass tube and the outer surface of the second glass tube together to form the optical preform.

22. The method of claim 20, further comprising depositing the coating layer between the inner surface and the outer surface by selectively heating a reactant gas disposed between the inner surface and the outer surface.
